(19) United States
(12) Patent Application Publication
(10) Pub. No.: US 2003/0004762 A1
(43) Pub. Date: Jan. 2, 2003

(54) Apparatus and method for augmenting a reservation system to provide user defined customized service

(75) Inventors: Dwip N. Banerjee, Austin, TX (US); Rabindranath Dutta, Austin, TX (US)

Correspondence Address: Duke W. Yee, Carstens, Yee & Cahoon, LLP, P.O. box 802334, Dallas, TX, 75380, US

(73) Assignee: International Business Machines Corporation, Armonk, NY (US)

(21) Appl. No.: 09/895,098

(22) Filed: Jun. 29, 2001

(51) Int. Cl. G06F 17/60

(52) U.S. Cl. 705/5

(57) ABSTRACT

An apparatus and method for augmenting a reservation system to provide user defined customized services are provided. The apparatus and method allow a user to enter parameters describing a customized service that the user wishes to obtain with regard to a reservation request. The parameters are then processed by the reservation system to determine if the requested customized service is within the rules and regulations of the reservation system. If the customized service is within the rules and regulations, the reservation system determines which service provider, if any, provides the requested service. A request is then sent to the service provider requesting the customized service. If the service provider responds with an acknowledgment that the service provider can provide the service, the reservation system accepts the customized service request and informs the user of the acceptance and any additional cost for the customized service. If the user confirms that he/she wishes to obtain the customized service, the reservation is completed and the customized service is scheduled. The user's account may then be billed for the total charge of the reservation and the customized service.

### BACKGROUND OF THE INVENTION

1. Technical Field

The present invention is directed to an improved computing device. More specifically, the present invention is directed to an apparatus and method for augmenting a reservation system to provide user defined customized service.

2. Description of Related Art

Online reservations systems are generally known in the art. Using an online reservation system, a user may designate various options regarding the reservation that the user wishes to obtain including date and time, seating, pickup and dropoff times, vehicle type, origination and destination locations, and the like.

The options are predefined by the reservation system. That is, the user is provided a listing of options from which the user may select options that he/she wishes to include with his/her reservation request. Thus, the user is limited to obtaining only those options that are specifically predefined and provided to the user. There is no mechanism by which the user may define the options that he/she wishes outside those that are predefined by the reservation system.

Therefore, it would be beneficial to have an apparatus and method for augmenting a reservation system to provide user defined customized service.

### SUMMARY OF THE INVENTION

The present invention provides an apparatus and method for augmenting a reservation system to provide user defined customized services. The apparatus and method of the present invention allow a user to enter parameters describing a customized service that the user wishes to obtain with regard to a reservation request. The parameters are then processed by the reservation system to determine if the requested customized service is within the rules and regulations of the reservation system.

If the customized service is within the rules and regulations, the reservation system determines which service provider, if any, provides the requested service. A request is then sent to the service provider requesting the customized service. If the service provider responds with an acknowledgment that the service provider can provide the service, the reservation system accepts the customized service request and informs the user of the acceptance and any additional cost for the customized service. Such interaction with the service provider may take many forms including, for example, a series of instant messages being sent between the reservation system and the service provider, a series of messages between the reservation system and the service provider associated with a negotiation for the customized service, an Internet telephony communication between a human associated with the reservation system and a human operator associated with the service provider, or the like. Alternatively, such interactions may be provided between the user requesting the customized service and the service provider and be facilitated by the reservation system. Moreover, such interactions may be between the user and the reservation system itself.

If the user confirms that he/she wishes to obtain the customized service, the reservation is completed and the customized service is scheduled. The user's account may then be billed for the total charge of the reservation and the customized service.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating a distributed data processing system in accordance with the present invention;

FIG. 2 is an exemplary diagram illustrating a server data processing device in accordance with the present invention;

FIG. 3 is an exemplary diagram illustrating a client data processing device in accordance with the present invention;

FIG. 4 is an exemplary block diagram of the operational components of the reservation server according to the present invention;

FIG. 5 is an exemplary block diagram of the operational components of a client device in accordance with the present invention;

FIG. 6 is a flowchart outlining an exemplary operation of a reservation server according to the present invention;

FIG. 7 is a flowchart outlining an exemplary operation of a client device in accordance with the present invention; and

FIG. 8 is an exemplary block diagram illustrating example service providers with which a reservation system may communicate in order to provide customized service in accordance with the present invention.

### DETAILED DESCRIPTION OF THE PREFERRED EMBODIMENT

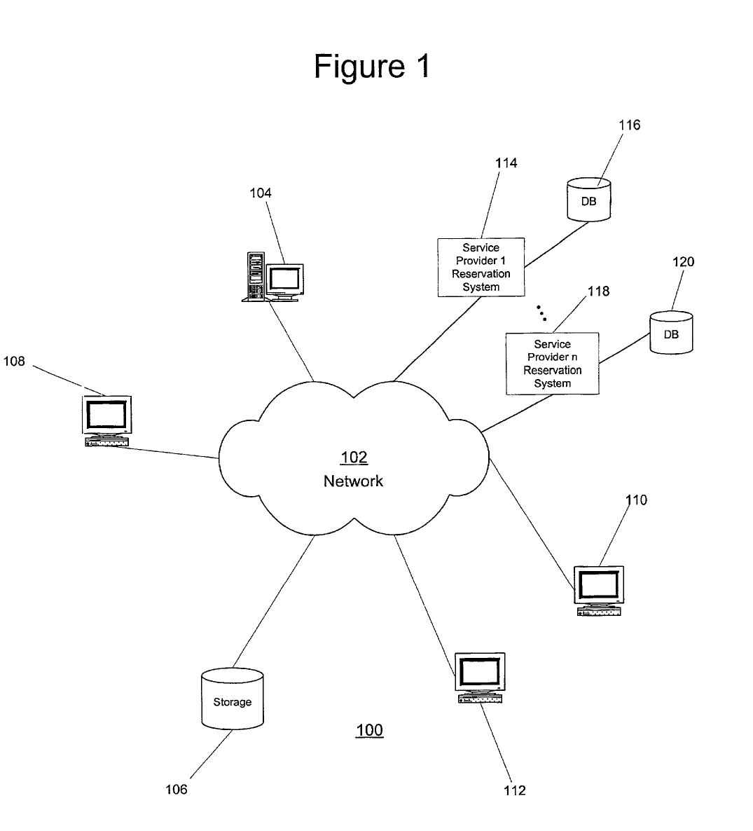

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. The server 104 may be a reservation server that is capable of making reservations in accordance with the present invention, as described in greater detail hereafter.

In addition, clients 108, 110, and 112 are connected to network 102. These clients 108, 110, and 112 may be, for example, personal computers, personal digital assistants, (PDAs), cellular telephones, wireless two-way pagers, network computers, or any other computing device capable of communication via the network 102. In a preferred embodiment, these client devices 108, 110 and 112 are modified to include software instructions for implementing client side operations of the present invention, as described hereafter. However, the present invention is not limited to such an embodiment and all of the operations of the present invention may be implemented in server 104 without departing from the spirit and scope of the present invention.

In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. of course, network data processing system 100 also may be implemented as a number of different types of networks, such as for example, an intranet, a local area network (LAN), or a wide area network (WAN). FIG. 1 is intended as an example, and not as an architectural limitation for the present invention.

Each of the client devices 108-112 are equipped with instructions for establishing reservation preferences for customization of reservations when in communication with reservation server 104. The reservation server 104 operates to make reservations for users of the client devices 108-112 based on the preferences communicated to the reservation server 104 by the client devices 108-112. These preferences include reservation features, e.g., services from service providers, which may have an associated cost premium associated with them due to these features being outside the rules and regulations of the reservation server 104. In this way, the user of a client device may designate that he/she wishes to obtain services that are not generally available to all users. The user may then be charged a premium for these “premier” services.

The service provider reservation systems 114 and 118 communicate with the reservation server 104 to inform the reservation server 104 if requested services are available. The service provider reservation systems 114 and 118 may then schedule the requested services and store the schedule in databases 116 and 120. The database 116 and 120 may further include additional information used by the service provider reservation systems 114 and 118 as appropriate.

While in the preferred embodiment the present invention is implemented as software instructions that are incorporated as part of a reservation server and client devices, the present invention is not limited to such an embodiment. Rather, the present invention may be implemented entirely within a reservation server that is accessible by users via client devices and a data network. In such an embodiment, the client devices themselves need not be modified in any manner from standard known client devices and may communicate with the reservation server in a known manner. Moreover, the present invention may be implemented in software, hardware, or a combination of software and hardware.

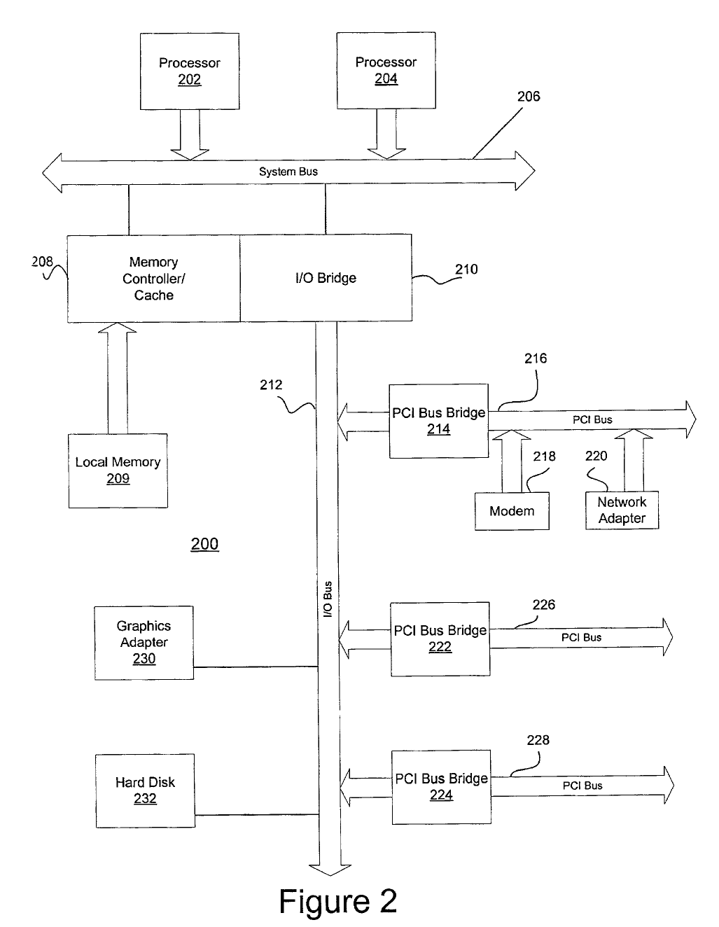

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

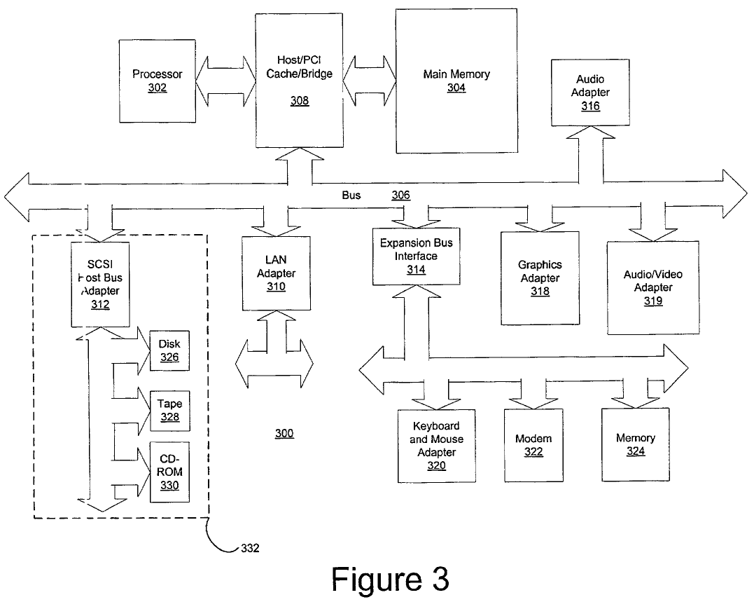

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned above, the present invention provides a mechanism by which a reservation system is augmented to provide services beyond the regular services offered by the reservation system. These customized services are defined by the user in a reservation request. The reservation system may then determine whether to accept the user defined customized service based on rules and regulations established with the reservation system and the availability of the user defined service.

The present invention makes use of a set of rules and regulations that define the regular services that may be provided by the reservation system. In addition to these rules, additional rules and regulations may be provided for defining “fuzzy” areas in which the rules and regulations for the regular services may be relaxed for privileged customers. The relaxation of the regular rules may be provided to a customer, when requested, in exchange for a cost premium to be paid by the customer.

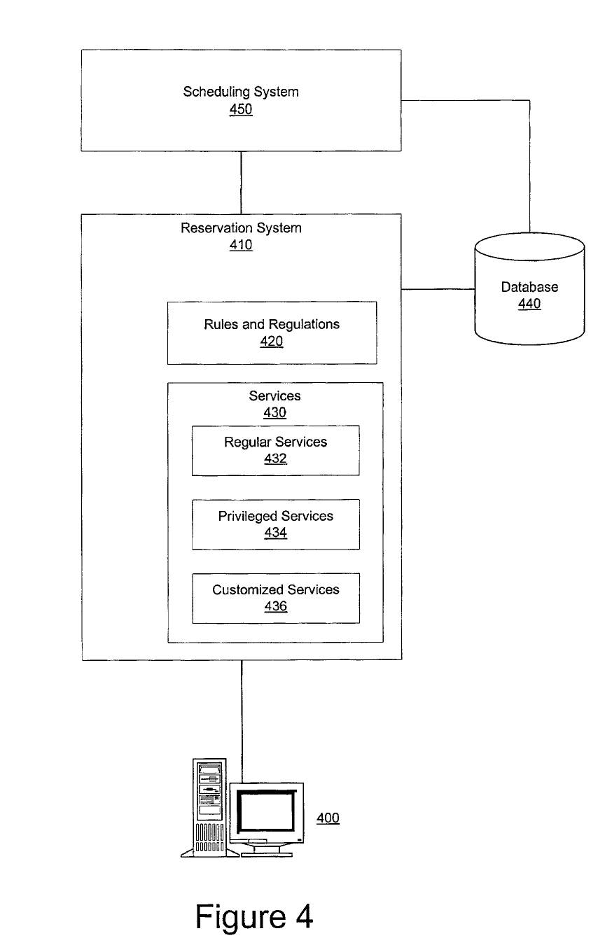

FIG. 4 is an exemplary block diagram of the operational components of a reservation server in accordance with the present invention. As shown in FIG. 4, the reservation server 400 includes a reservation system 410, a scheduling system 450 and a database 440. The reservation system 410 is used to interface with client devices to receive reservation requests, authenticate requested services, and make reservations. The scheduling system 450 is used to communicate with service providers to schedule providing of services requested by client devices through the reservation system 410. The database 440 is used to store reservations and customer profiles for use with the reservation system 410.

The reservation system 410 includes a set of rules and regulations 420 that define the limits of the services that may be provided by the reservation system. The rules and regulations 420 define the limits of regular services that are provided to all customers. In addition, these rules and regulations 420 may include rules and regulations that define fuzzy areas in which the regular services may be expanded to privileged and customized services for certain customers.

In addition to the rules and regulations 420, the reservation system 410 includes predefined services 430. The predefined services 430 include regular services 432 that are provided to all customers and privileged services 434 that are provided to certain groups of customers.

Privileged services, as the term is used herein, are services beyond those provided in the regular services, that are provided to a predefined class of customers. Thus, privileged services are those services that are offered to a particular group of customers. For example, if an airline is celebrating its 50th anniversary, the airline may choose to offer a special meal upgrade to customers that have flown on the airline more than 25 times. Thus, any customer that falls into the group of having flown on the airline 25 times will be provided with the option of using this privileged service.

In addition to the above, the reservation system 410 includes a customized service handler 436 which receives requests for customized services and handles acceptance or denial of the customized service request. Customized services, as the term is used herein, refers to services that are not predefined by the reservation system. These are services that are defined by the user in a reservation request. For example, a user may request that, as part of an airline meal upgrade, he be served caviar with his meal. This is a service that is not provided with regular services and is not something that the airline is offering as a privileged service, but is rather, simply something that the user is requesting without being told that it is available a priori.

When the reservation system 410 receives a request for a customized service, the reservation system 410 must check the parameters of the request against the rules and regulations to see if the customized service is able to be provided within the rules and regulations. In addition, if an outside service provider is required to provide the customized service, the reservation system 410 must check with the service provider to make sure that it can satisfy the requested customized service before accepting the request for the customized service.

The reservation system 410 may check with the service provider in an automated manner, such as sending a request to the reservation system 410, or in a semi-manual manner. In the automated manner the reservation system 410 sends a request to a service provider system requesting the customized service. The service provider system may then check its internal databases, rules, etc. to determine if the requested customized service may be provided. If so, the service provider system may return a response indicating that the customized service may be provided and the details of providing the customized service, such as price, date and time, etc.

In the semi-automated manner, the reservation system 410 may, upon receiving a request for a customized service, initiate a communication session between a human operator associated with the reservation system 410 and a human operator of the service provider system. Such a communication session may take the form of an instant messaging communication, a data network telephony session, a conventional telephone communication session, an electronic mail based communication session, or the like. Such communication assumes that the address, such as instant messaging address, telephone number, or the like, is available to the reservation system 410 such that the reservation system 410 may initiate the communication session. Any mechanism for facilitating the communication between the human operators may be used without departing from the spirit and scope of the present invention.

The communication session between the human operators may take the form of a request by the human operator of the reservation system 410 and acceptance or denial by the human operator of the service provider. Alternatively, the communication session may be a negotiation between the human operators in which terms of providing the customized service are negotiated through a series of offers, counteroffers, and ultimately acceptance or rejection of the offers and/or counteroffers. Alternatively, reservation daemon processes may be provided that have the artificial intelligence to contact service supplier daemon processes to perform automatic negotiations based on established rules. In such a case, human override options may be provided to override the automatic negotiations.

Once the request for the customized service is ultimately accepted or rejected, in either the automatic or semiautomatic manner, the reservation system 410 may communicate either acceptance or rejection of the customized service to the requesting user. If providing of the customized service is accepted, the terms of acceptance may be provided to the requesting user and an opportunity for the user to agree to or not agree to these terms is provided. The terms of acceptance may involve pricing, and the like, in which profit for the operators of the reservation system 410 may be factored in. Thus, the terms of acceptance may or may not be the same as the terms accepted by the service provider.

With the present invention, a user may log onto the reservation server 400 using a software interface. This interface may be a browser application running on the client device, a graphical user interface provided in the client device, or the like. Alternatively, upon logging onto the reservation server 400, the interface may be downloaded to the client device as an applet, script, or the like.

Through the interface, the user of the client device may register with the reservation system 410. Such registration may include, for example, providing personal information and billing information to the reservation system 410. In addition, the user may provide personal reference information for reservation services. The information provided by the user is stored as a user profile in the database 440 and is retrievable based on a user identifier.

Some users may be considered to be privileged users to which privileged services and customized services are made available. The categorization of the users as privileged users may be performed in any appropriate manner. For example, a user may be considered a privileged user if the user has an income above a certain threshold, has used the airline a certain number of times previously, has a business account with the airline, has a credit card or frequent flier card associated with the airline, uses the services of affiliated service providers, switches his/her long distance telephone service provider, subscribes to being a privileged user, or the like.

The categorization may be performed based on the information provided by the user during the registration of the user with the reservation system 410, for example. The categorization may also be performed based on factors other than, or in addition to, the information provided by the user during registration. Moreover, the user may be recategorized at a later time such that the user is recategorized as a privileged user.

Regardless of the mechanism for categorizing the user as a privileged user, the user profile in the database 440 preferably stores an indicator of whether the user is privileged or not. Privileged users are users to which privileged services may be advertised and/or from which customized service requests may be accepted.

In addition to, or in replacement of, the user profile stored in the database 440, the client device may make use of cookies to provide information to the reservation system. The use of cookies with data network servers is generally known in the art. The present invention may make use of cookies to upload user identification and profile information to the reservation system 410. The cookies may further be used to upload requests for customized services that the user tends to repeatedly request. Other mechanisms for informing the reservation system 410 of the user identification, profile, and customized service request information may be used without departing from the spirit and scope of the present invention.

When the user logs onto the server 400 using his/her client device, the user makes use of an interface, such as a graphical user interface (GUI), for inputting reservation requests. As mentioned above, the GUI may be present on the client device itself, such as a plugin to a web browser or the like, or may be provided by the reservation server 400 upon logon, such as in an applet, script or the like. The GUI presented to the user may be customized based on whether or not the user is a privileged user or not. That is, certain options that are not available to all users may be included in the GUI when the user is determined to be a privileged user.

Using the GUI, the user may select regular services and privileged services (if the user is privileged) from available options presented through the GUI. In addition, if the user is a privileged user, the GUI may include one or more fields for entering parameters regarding a request for customized services. These parameters may include one or more parameters that describe the service requested, such as brand name of drink requested, a quantity, a requested maximum price for the customized service, and the like. The parameters are user defined and are not predefined parameters from which the user chooses. Thus, the user is capable of entering any type of customized service that the user wishes to obtain from the reservation system 410 without being limited in his/her choices to predefined services.

The parameters of the requested customized service are received by the reservation system 410 and provided to the customized service handler 436. The customized service handler 436 applies the received parameters to the rules and regulations 420 and determines if the customized service may be provided within the rules and regulations.

For example, typically, an airline may limit the number of bags that a passenger may check to two per passenger. As a customized service, the user may request that they be able to check five bags rather than the normal two. The customized service handler 436 may compare the request for checking five bags against the rules and regulations 420 in the reservation system 410 and determine that while normally only two bags may be checked, the rules and regulations 420 indicate that, based upon space availability, additional bags may be checked for an additional cost of $50.00 per bag. Thus, the requested customized service may be provided within the limits defined by the rules and regulations 420.

However, when a request for customized services meets the requirements of the rules and regulations 420, if the service is to be supplied by an outside service provider, the availability of the service from the service provider must also be determined. In such a case, the customized service handler 436 communicates with the reservation system of the service provider to request that the customized service be provided. The customized service handler 436 determines which service provider to communicate with based on service provider information stored in database 440. This service provider information may include contact information for communicating with the service provider, as well as information regarding the services available from the service provider.

Based on the service provider information retrieved from the database 440, the customized service handler 436 transmits a request for the customized service to the service provider. The service provider may then process the request and determine whether it can provide the requested service. Such a determination may be made first based on whether the service provider even provides the requested service, and second based on whether the service provider is capable of providing the requested service at the requested time, e.g., for a flight that is leaving Dallas-Ft. Worth Airport at 10:36 am on January 6th.

Alternatively, as previously mentioned, the customized service handler 436 may initiate a communication session between a human operator of the reservation system and the service provider. Such a communication session may include instant messaging, data network telephony, conventional telephone communication, electronic mail messaging, and the like. The communication session may be of a request and acceptance or denial type or may be a negotiation type of communication session in which a plurality of messages are relayed back and forth between the parties.

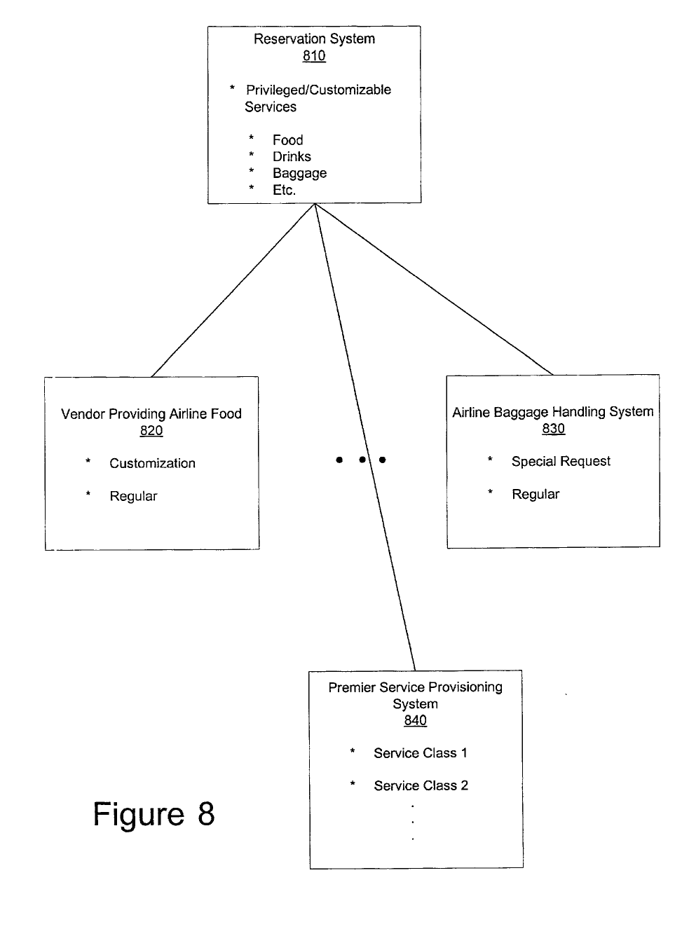

FIG. 8 provides an exemplary diagram that illustrates some of the service providers that may be used with a reservation system according to the present invention. As shown in FIG. 8, an airline reservation system 810 may communicate with a vendor providing airline food 820 to determine if customized meal selections may be obtained from the vendor 820. In addition, the airline reservation system 810 may communicate with an airline baggage handling system 830 to determine if a special request for baggage handling, such as a increased number of checked bags, may be provided by the airline baggage handling system 830. Moreover, the airline reservation system 810 may communicate with a premier service provisioning system 840 to determine if a particular class of service may be provided based on the requested customized service to thereby satisfy the request for customized service. Other systems not shown in FIG. 8 may also be queried based on the particular customized service request.

Returning to FIG. 4, if the service provider determines that it can provide the requested service, the service provider may return an acknowledgment to the customized service handler 436. This acknowledgment may include an indication of the price charged by the service provider for providing the service. Alternatively, if a communication session between human operators is used, the human operator of the reservation system may input the acceptance terms and the terms to which the requesting user must agree to obtain the requested customized service.

Based on this acknowledgment, the customized service handler 436 may inform the user that the request for a customized service has been accepted and inform the user of the additional charge for the customized service should the user confirm that he/she wishes to obtain the customized service at the associated extra cost.

If the user transmits a confirmation of acceptance of the customized service at the associated cost, the reservation system 410 may instruct the scheduling system 450 to schedule the reservation and the requested customized service. The scheduling system 450 will then update appropriate records in the database 440 to reflect the scheduling of the reservation and the requested customized service. The scheduling system 450 further schedules the customized service with the service provider. The user's account, identified by the user profile and/or cookie information, may then be billed for the total cost of the reservation and the customized service.

Thus, with the present invention, a user may request services that are not provided to all customers. Moreover, the user may request services that are not predefined by the reservation system 410. In this way, the user has more freedom in requesting services that he/she wishes to obtain from the reservation system.

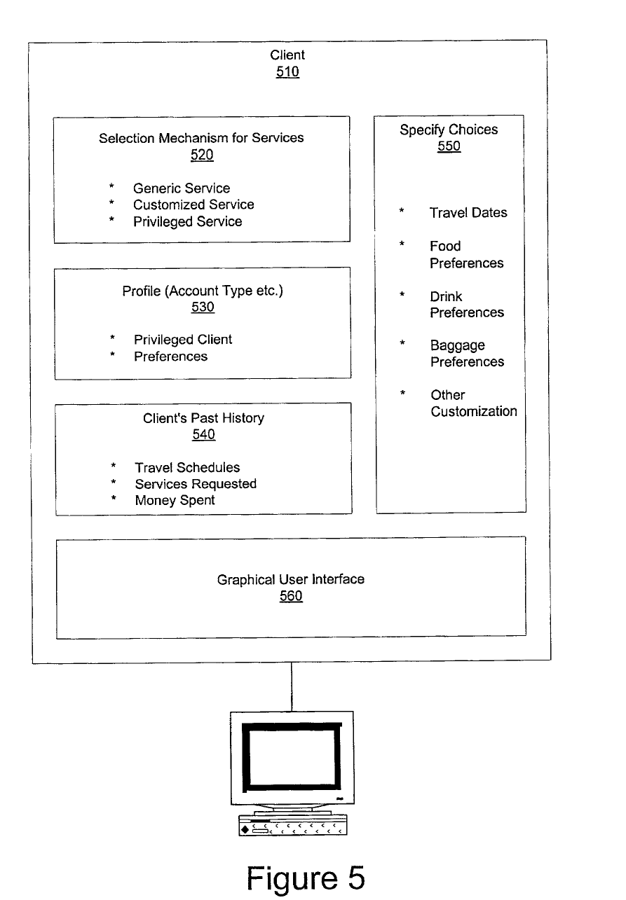

FIG. 5 is an exemplary block diagram illustrating the operational components of a client computer in accordance with the present invention. The components shown in FIG. 5 are preferably implemented as computer instructions executed by the client computer 510. These instructions provide an interface for communicating with the reservation server 400. As noted above, the interface may be resident on the client computer or may be downloaded to the client computer as an applet, script, or the like, upon logging on to the reservation server 400.

As shown in FIG. 5, the client 510 includes selection mechanism 520 for selecting various service levels. These service levels include generic or regular service, privileged service, or customized service. The user may select which level of service he/she wishes and the reservation server 400 will determine whether the user is authorized for that level of service based on information stored in a user profile, for example. Alternatively, there may be a surcharge associated with providing privileged or customized service. Thus, if a user is willing to pay the surcharge for being treated as a privileged or customized service level customer, the user may be provided with this level of service.

The client 510 may further include a user profile 530. The user profile may include an indication of the status of the user as being a privileged client or regular client. In addition, the user profile may include an indication of the preferences, billing information, and the like, of the user. As mentioned previously, rather than storing the client profile on the client 510, this profile may be stored in the database 440 and accessible via a user identifier, for example.

The client 510 further includes a history data structure 540 that stores information regarding past reservations made by the user using the interface. This may include previous travel schedules, services requested, money spent, and the like. As with the user profile, this history data structure may be stored on the reservation server 400 in the database 440 in association with the user profile, rather than on the client 510.

The client 510 may further include fields 550 for specifying choices for setting up the reservation and for services that are to be provided. These fields 550 may include predefined options for regular services and privileged services, if the user is determined to be a privileged user. In addition, these fields 550 may include fields for entering one or more freeform parameters for defining a customized service that is requested by the user.

All of these components of the client 510 may be accessible via the graphical user interface 560. The client 510 receives inputs from a user via the graphical user interface 560 and transmits the reservation request to the reservation server 400 via a network interface. The graphical user interface 560 may further be used to provide acknowledgments of acceptance of the reservation request and other information to the user as appropriate.

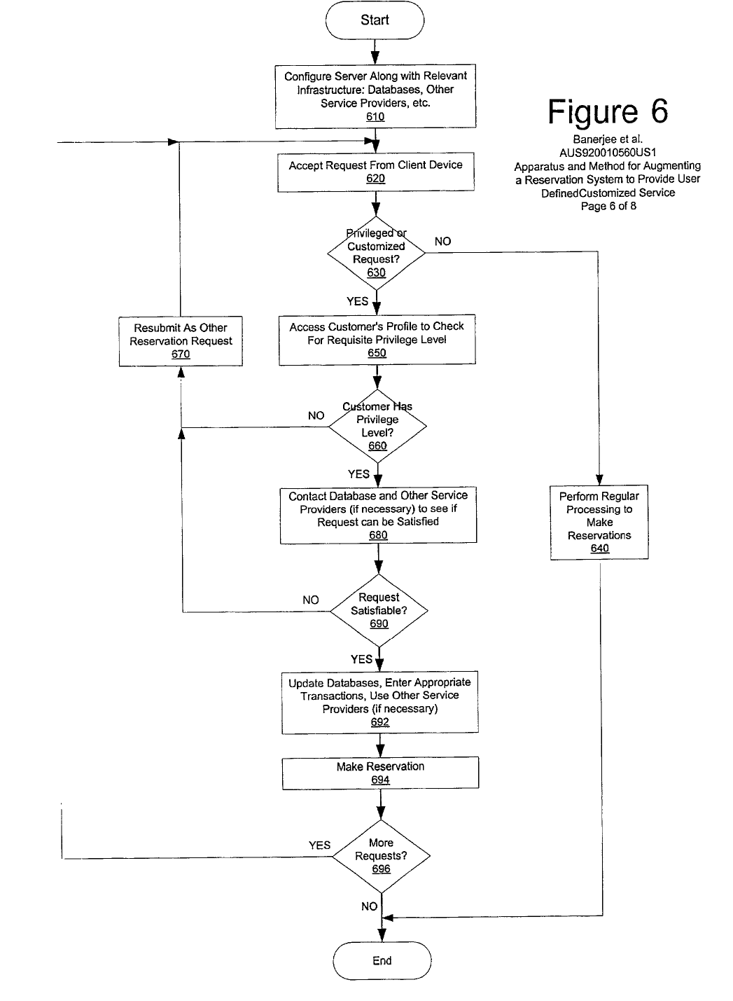

FIG. 6 is a flowchart outlining an exemplary operation of the present invention. As shown in FIG. 6, the operation starts with the configuration of the server along with relevant infrastructure including databases, other service providers, and the like (step 610). A request is then received from a client device (step 620). A determination is made as to whether the request is a privileged or customized service request (step 630).

If the request is not for a privileged or customized service, the reservation is handled in a normal manner (step 640) If the request is for a privileged or customized service, the customer's profile is checked for the requisite privilege level (step 650). A determination is made as to whether the customer has the requisite privilege level (step 660). If not, the request is resubmitted as another type of reservation request (step 670) after the customer either modifies the request or applies for and acquires a status upgrade. Thus, either a new request that may be satisfied is submitted, or the same request may be resubmitted after the user acquires the required privileged to obtain the requested service.

If the customer does have the requisite privilege level, the database and other service providers are contacted to determine if the request is satisfiable (step 680). A determination is made as to whether the request is satisfiable (step 690). If not, the request is resubmitted in step 670. If the request is satisfiable, the database is updated and appropriate transactions are performed with the other service providers to secure the requested service (step 692). The reservation is then completed (step 694) and a determination is made as to whether there are any more requests (step 696). If so, the operation returns to step 620. Otherwise, the operation ends.

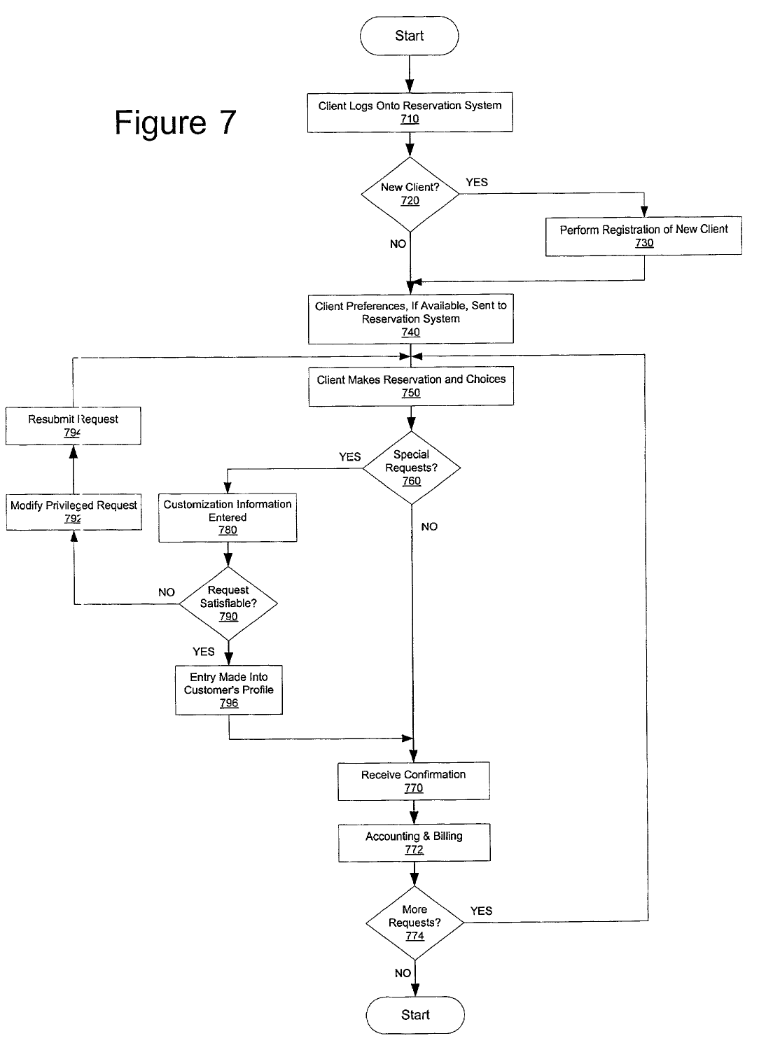

FIG. 7 is a flowchart outlining an exemplary operation of the client device in accordance with the present invention. As shown in FIG. 7, the operation starts with the client device logging onto the reservation system (step 710). A determination is made as to whether the client device is a new client device (step 720). If the client device is a new client device, the client registers with the reservation system (step 730). Thereafter, or if the client is not a new client, the client sends the client preferences to the reservation system (step 740). As mentioned previously, in one embodiment, the reservation system may already store the user profile in a database and thus, this step may be replaced by transmitting a user identifier to the reservation system. The reservation system may then use this user identifier to retrieve the user profile from the database.

Thereafter, the client device provides a reservation request and service selections (step 750). A determination is made as to whether the user wishes to enter special requests for services (step 760). If so, customization information is entered (step 780) and a determination is made as to whether the request is satisfiable (step 790). If the request is not satisfiable, the privileged request may be modified by the user (step 792) and the request is resubmitted (step 794). Alternatively, as mentioned above with regard to FIG. 6, the user may apply for and obtain a status upgrade and resubmit the same request once the user has acquired the requisite privilege level.

If the request is satisfiable, an entry is made into the customer's profile (step 796) to log the request in a manner as to update the preferences for this user. In this way, the system automatically updates the user's preference for use with future service requests.

Thereafter, or if the reservation does not include special requests in step 760, the client device receives confirmation of the reservation (step 770). The client device then provides payment via an accounting and billing interface (step 772). A determination is then made as to whether there are additional requests (step 774). If so, the operation returns to step 750, otherwise the operation ends.

Thus, the present invention provides a system for augmenting a reservation system so that the reservation system is capable of handling privileged and customized service requests. The reservation system of the present invention is capable of receiving requests for customized services that are not predefined by the reservation system. The reservation system is further capable of investigating whether the customized service may be provided and at what cost the customized service may be provided to the requester. The reservation system is then able to schedule the customized service so that it is provided to the user in association with the user's reservation.

Although the examples provided above are directed to an airline reservation system, the invention is not limited to such. The airline reservation system is provided only as an example and not intended to imply an limitations on the present invention. The present invention may be used with any reservation system including hotel reservations, car reservations, cruise line reservations, and the like.

Furthermore, although the preferred embodiments have been described in terms of a data network, such as the Internet, the present invention is not limited to such. Rather, the present invention may be used with any type of network including wireless networks, infrared networks, satellite networks, optical networks, and the like. For example, the present invention may be implemented in a wireless network that makes use of a Wireless Application Protocol (WAP), Bluetooth™ network protocol, or the like.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of accepting reservation requests in a reservation system, comprising:
receiving a request for a customized service, wherein the request includes customized service parameters that are not predefined by the reservation system;
determining if the customized service may be provided based on the customized service parameters; and
accepting the request for the customized service if the customized service may be provided.

2. The method of claim 1, wherein determining if the customized service may be provided includes comparing the customized service parameters to a set of rules associated with the reservation system.

3. The method of claim 2, wherein the rules include rules that are applicable to standard users and rules that define fuzzy areas in which the rules applied to standard users may be relaxed for privileged users.

4. The method of claim 3, wherein if the customized service parameters fall within the rules that are applicable to standard users, the customized service is determined to be able to be provided.

5. The method of claim 3, wherein determining if the customized service may be provided further includes:
determining whether a submitter of the request is a privileged user if the customized service parameters fall within the rules that define the fuzzy areas; and
determining that the customized service is able to be provided if the customized service parameters fall within the rules that define the fuzzy areas and the submitter is a privileged user.

6. The method of claim 5, wherein determining if the customized service may be provided further includes:
requesting the customized service from a service provider;
receiving a response from the service provider; and
determining that the customized service may be provided if the response from the service provider indicates that the service provider can provide the customized service.

7. The method of claim 1, further comprising:
providing a software interface to a client computer, wherein the software interface may be used to submit the request for the customized service.

8. The method of claim 7, wherein the software interface is one of an applet and a script.

9. The method of claim 1, further comprising:
making a reservation based on the request for the customized service; and
scheduling the customized service.

10. The method of claim 9, wherein scheduling the customized service includes scheduling the customized service with one or more service provider reservation systems.

11. A computer program product in a computer readable medium for accepting reservation requests in a reservation system, comprising:
first instructions for receiving a request for a customized service, wherein the request includes customized service parameters that are not predefined by the reservation system;
second instructions for determining if the customized service may be provided based on the customized service parameters; and
third instructions for accepting the request for the customized service if the customized service may be provided.

12. The computer program product of claim 11, wherein the second instructions for determining if the customized service may be provided include instructions for comparing the customized service parameters to a set of rules associated with the reservation system.

13. The computer program product of claim 12, wherein the rules include rules that are applicable to standard users and rules that define fuzzy areas in which the rules applied to standard users may be relaxed for privileged users.

14. The computer program product of claim 13, wherein if the customized service parameters fall within the rules that are applicable to standard users, the customized service is determined to be able to be provided.

15. The computer program product of claim 13, wherein the second instructions for determining if the customized service may be provided further include:
instructions for determining whether a submitter of the request is a privileged user if the customized service parameters fall within the rules that define the fuzzy areas; and
instructions for determining that the customized service is able to be provided if the customized service parameters fall within the rules that define the fuzzy areas and the submitter is a privileged user.

16. The computer program product of claim 15, wherein the second instructions for determining if the customized service may be provided further include:
instructions for requesting the customized service from a service provider;
instructions for receiving a response from the service provider; and
instructions for determining that the customized service may be provided if the response from the service provider indicates that the service provider can provide the customized service.

17. The computer program product of claim 11, further comprising:
fourth instructions for providing a software interface to a client computer, wherein the software interface may be used to submit the request for the customized service.

18. The computer program product of claim 17, wherein the software interface is one of an applet and a script.

19. The computer program product of claim 11, further comprising:
fourth instructions for making a reservation based on the request for the customized service; and
fifth instructions for scheduling the customized service.

20. The computer program product of claim 19, wherein the fifth instructions for scheduling the customized service include instructions for scheduling the customized service with one or more service provider reservation systems.

21. An apparatus for accepting reservation requests in a reservation system, comprising:
means for receiving a request for a customized service, wherein the request includes customized service parameters that are not predefined by the reservation system;
means for determining if the customized service may be provided based on the customized service parameters; and
means for accepting the request for the customized service if the customized service may be provided.

22. The apparatus of claim 21, wherein the means for determining if the customized service may be provided includes means for comparing the customized service parameters to a set of rules associated with the reservation system.

23. The apparatus of claim 22, wherein the rules include rules that are applicable to standard users and rules that define fuzzy areas in which the rules applied to standard users may be relaxed for privileged users.

24. The apparatus of claim 23, wherein if the customized service parameters fall within the rules that are applicable to standard users, the customized service is determined to be able to be provided.

25. The apparatus of claim 23, wherein the means for determining if the customized service may be provided further includes:
means for determining whether a submitter of the request is a privileged user if the customized service parameters fall within the rules that define the fuzzy areas; and
means for determining that the customized service is able to be provided if the customized service parameters fall within the rules that define the fuzzy areas and the submitter is a privileged user.

26. The apparatus of claim 25, wherein the means for determining if the customized service may be provided further includes:
means for requesting the customized service from a service provider;
means for receiving a response from the service provider; and
means for determining that the customized service may be provided if the response from the service provider indicates that the service provider can provide the customized service.

27. The apparatus of claim 21, further comprising:
means for providing a software interface to a client computer, wherein the software interface may be used to submit the request for the customized service.

28. The apparatus of claim 27, wherein the software interface is one of an applet and a script.

29. The apparatus of claim 21, further comprising:
means for making a reservation based on the request for the customized service; and
means for scheduling the customized service.

30. The apparatus of claim 29, wherein the means for scheduling the customized service includes means for scheduling the customized service with one or more service provider reservation systems.

31. A reservation system, comprising:
a reservation server; and
at least one client device coupled to the reservation server, wherein the client device submits a request for a customized service to the reservation server, the request including one or more customized service parameters that are not predefined by the reservation server, and wherein the reservation server determines if the customized service may be provided based on the one or more customized service parameters and accepts the request for the customized service if the customized service may be provided.

32. The system of claim 31, wherein the at least one client device is coupled to the reservation server via at least one of a data network, a telecommunications network, a cellular network, a satellite communication network, an infrared communication network, a Bluetooth network, and a Wireless Application Protocol network.

33. The system of claim 31, wherein the reservation server transmits a software interface to the at least one client device, and wherein the at least one client device uses the software interface to submit the request.

34. The system of claim 33, wherein the software interface is one of an applet and a script.

35. The method of claim 1, wherein determining if the customized service may be provided based on the customized service parameters includes initiating a communication session between a first party associated with the reservation system and a second party associated with a service provider.

36. The method of claim 35, wherein the communication session includes at least one of instant messaging, electronic mail messaging, data network telephony, and conventional telephone communication.

37. The method of claim 35, wherein the communication session includes a negotiation between the first party and the second party.

38. The apparatus of claim 21, wherein the means for determining if the customized service may be provided based on the customized service parameters includes means for initiating a communication session between a first party associated with the reservation system and a second party associated with a service provider.

39. The apparatus of claim 38, wherein the communication session includes at least one of instant messaging, electronic mail messaging, data network telephony, and conventional telephone communication.

40. The apparatus of claim 38, wherein the communication session includes a negotiation between the first party and the second party.

41. The computer program product of claim 11, wherein the second instructions for determining if the customized service may be provided based on the customized service parameters include instructions for initiating a communication session between a first party associated with the reservation system and a second party associated with a service provider.

42. The computer program product of claim of claim 41, wherein the communication session includes at least one of instant messaging, electronic mail messaging, data network telephony, and conventional telephone communication.

43. The computer program product of claim 41, wherein the communication session includes a negotiation between the first party and the second party.

44. A method of accepting reservation requests in a reservation system, comprising:
receiving a request for a customized service as a result of a user interaction with a web page displayed on a user device, wherein the request includes customized service parameters that are not predefined by the reservation system;
responsive to detecting a customized service request, initiating a real-time communication session between a user associated with the user device and a representative associated with a service provider, wherein one endpoint of the communication session is the user device; and
accepting the request for the customized service if the customized service may be provided by the service provider.

45. The method of claim 44, wherein a fee and arrangements for the customized service are negotiated.
